(19) United States
(12) Patent Application Publication
(10) Pub. No.: US 2017/0253747 A1
(43) Pub. Date: Sep. 7, 2017

(54) HARD COATING COMPOSITION

(71) Applicant: DONGWOO FINE-CHEM CO., LTD., Iksan-si (KR)

(72) Inventors: Geo San Lim, Seoul (KR); Eun Young Kim, Pyeongtaek-si (KR); Seung Hee Kim, Seoul (KR)

(21) Appl. No.: 15/449,025

(22) Filed: Mar. 3, 2017

(30) Foreign Application Priority Data
Mar. 4, 2016 (KR) 10-2016-0026577
Feb. 21, 2017 (KR) 10-2017-0023028

(51) Int. Cl. C09D 4/00; G02B 1/14

(52) U.S. Cl. CPC C09D 4/00; G02B 1/14

(57) ABSTRACT

The present invention relates to a hard coating composition, and more particularly, to a hard coating composition which includes a high elongation oligomer having an elastic modulus and an elongation at break in a specific range and thus exhibits excellent impact resistance and bending resistance.

### CROSS-REFERENCE TO RELATED APPLICATIONS

This application claims priority to and the benefit of Korean Patent Application No. 10-2016-0026577, filed on Mar. 4, 2016, and Korean Patent Application No. 10-2017-0023028, filed on Feb. 21, 2017, the disclosures of which are incorporated herein by reference in their entirety.

### FIELD OF THE INVENTION

The present invention relates to a hard coating composition having excellent impact resistance and bending resistance.

### BACKGROUND

As mobile devices such as smart phones, tablet PCs have been developed in recent years, thinner and slimmer display substrates have been required. Glass or tempered glass as a material having excellent mechanical properties has been generally used for a display window or a front plate of these mobile devices. However, the glass causes a weight of the mobile devices to be heavy due to its own weight, and has a problem of damage due to an external impact.

Therefore, plastic resins are being studied as a substitute for glass. A plastic resin composition is appropriate for the trend of pursuing a lighter mobile device because it is lightweight and is less likely to be broken. In particular, a composition in which a supporting substrate is coated with a hard coating layer has been proposed to achieve a composition having high-hardness and wear resistance.

As a method of improving surface hardness of a hard coating layer, a method in which the thickness of a hard coating layer increases can be considered. In order to ensure enough surface hardness to substitute for glass, it is necessary to realize a constant thickness of a hard coating layer.

As the thickness of a hard coating layer increases, surface hardness may increase. However, wrinkling or curling increases due to cure shrinkage of a hard coating layer and simultaneously a hard coating layer is likely to be cracked or peeled off. Therefore, it is not easy to practically apply the method.

Recently, several methods for realizing high-hardness of a hard coating film and simultaneously solving a problem of cracking of a hard coating layer or a curl caused by cure shrinkage have been proposed.

In Korean Patent Publication No.2014-0027022, a hard coating composition which includes an acrylate monomer and a photocurable elastomer having an elongation in a predetermined range and thus exhibits improved impact resistance is disclosed. However, the hard coating composition disclosed above does not exhibit enough bending resistance and impact resistance to substitute for a glass panel of a display.

In Korean Patent Publication No.2011-0078783, a hard coating composition which includes an alkylene-glycol-based acrylic monomer at 5 to 80 wt % and thus exhibits improved surface hardness and impact resistance is disclosed. However, the hard coating composition disclosed above also does not exhibit enough impact resistance to substitute for a glass panel of a display.

### PRIOR-ART DOCUMENTS

### Patent Documents

Korean Patent Publication No.2014-0027022 (Mar. 6, 2014; LG Chem Ltd.)

Korean Patent Publication No.2011-0078783 (Jul. 7, 2011; Cheil Industries Inc.)

### SUMMARY OF THE INVENTION

The present invention is directed to providing a hard coating composition which exhibits excellent impact resistance and bending resistance.

In order to accomplish the above object, a hard coating composition according to the present invention includes a high elongation oligomer having an elastic modulus ranging from 10 to 3000 MPa and an elongation at break ranging from 30 to 150%.

A hard coating composition according to the present invention includes a high elongation oligomer having an elastic modulus and an elongation at break in a specific range and thus can exhibit improved impact resistance and bending resistance.

### DETAILED DESCRIPTION OF EMBODIMENTS

In the present invention, when a portion “includes” an element, another element may be further included, rather than excluding the presence of the other element, unless otherwise described.

Hereinafter, the present invention will be described in detail with reference to exemplary embodiments.

### Hard Coating Composition

A hard coating composition according to one exemplary embodiment of the present invention includes a high elongation oligomer having an elastic modulus ranging from 10 to 3000 MPa and an elongation at break ranging from 30 to 150%. When the hard coating composition has an elastic modulus and an elongation at break within these ranges, excellent bending resistance and impact resistance can be exhibited.

### High Elongation Oligomer

The hard coating composition according to the present invention includes a high elongation oligomer.

The high elongation oligomer includes a photocurable (meth)acrylate oligomer.

The photocurable (meth)acrylate oligomer may include one or more selected from the group consisting of epoxy (meth)acrylate, urethane (meth)acrylate, and polyester (meth)acrylate.

The epoxy (meth)acrylate may be obtained by reacting a carboxylic acid having a (meth)acryloyl group with an epoxy compound. Specifically, the epoxy compound may be glycidyl (meth)acrylate, C1 to C12 linear alcohol-terminated glycidyl ether, diethylene glycol diglycidyl ether, tripropylene glycol diglycidyl ether, bisphenol A diglycidyl ether, ethylene oxide modified bisphenol A diglycidyl ether, propylene oxide modified bisphenol A diglycidyl ether, trimethylolpropane triglycidyl ether, pentaerythritol tetraglycidyl ether, hydrogenated bisphenol A diglycidyl ether, glycerin diglycidyl ether, or the like. The carboxylic acid having a (meth)acryloyl group may be (meth)acrylic acid, 2-(meth)acryloyloxyethyl succinic acid, 2-(meth)acryloyloxyethyl hexahydrophthalic acid, or the like.

The urethane (meth)acrylate may be prepared by reacting a multifunctional (meth)acrylate having a hydroxyl group in a molecule and a compound having an isocyanate group in the presence of a catalyst.

The (meth)acrylate having a hydroxyl group in a molecule may be one or more selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, a mixture of pentaerythritol tri- and tetra-(meth)acrylate, and a mixture of dipentaerythritol penta- and hexa-(meth)acrylate.

The compound having an isocyanate group in a molecule may be one or more selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexyl isocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′-oxybis(phenyl isocyanate), tri-functional isocyanate derived from hexamethylene diisocyanate, and trimethane propanol adduct toluene diisocyanate.

The polyester (meth)acrylate may be, specifically, a diacrylate such as ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, 1,4-butanediol di(meth)acrylate, neopentyl glycol di(meth)acrylate, 1,6-hexanediol di(meth)acrylate, tricyclodecane di(meth)acrylate, bisphenol A di(meth)acrylate, and the like, trimethylolpropane tri(meth)acrylate, pentaerythritol tri(meth)acrylate, pentaerythritol tetra(meth)acrylate, ditrimethylolpropane tetra(meth)acrylate, dipentaerythritol penta(meth)acrylate, dipentaerythritol hexa(meth)acrylate, tris(2-(meth)acryloyloxyethyl)isocyanurate, or the like.

It is preferable that the urethane (meth)acrylate and the polyester (meth)acrylate be used in combination or both polyester and urethane groups be included in one molecule.

In particular, an acrylate oligomer having a linear structure may be used to form a hard coating film having an elongation of 30% or more. Preferably, a polyester (meth)acrylate which has a linear structure and exhibits excellent flexibility is used.

The high elongation oligomer may be preferably included at 1 to 90 wt %, more preferably, 5 to 80 wt % with respect to 100 wt % of the entire hard coating composition. When a content of the high elongation oligomer is less than 1 wt %, it is difficult to form a coated film or to manufacture the hard coating composition having a sufficient level of impact resistance even when a coated film is formed. On the other hand, when a content thereof is greater than 90 wt %, uniformity of a coated film may be degraded due to high viscosity during the manufacture of a hard coating film using the hard coating composition.

In one exemplary embodiment of the present invention, the hard coating composition may further include one or more selected from the group consisting of a solvent, a photoinitiator and an additive.

### Solvent

The solvent is a material that may dissolve or disperse the above-described composition and may be used without limitation as long as it is known as a solvent of a hard coating composition in the art.

Specifically, the solvent may preferably be alcohols (e.g., methanol, ethanol, isopropanol, butanol, methyl cellosolve, ethyl cellosolve, and the like), ketones (e.g., methyl ethyl ketone, methyl butyl ketone, methyl isobutyl ketone, diethyl ketone, dipropyl ketone, cyclohexanone, and the like), acetates (e.g., ethyl acetate, propyl acetate, n-butyl acetate, t-butyl acetate, methyl cellosolve acetate, ethyl cellosolve acetate, propylene glycol monomethyl ether acetate, propylene glycol monoethyl ether acetate, propylene glycol monopropyl ether acetate, methoxybutyl acetate, methoxypentyl acetate, and the like), alkanes (e.g., hexane, heptane, octane, and the like), benzene or derivatives thereof (e.g., benzene, toluene, xylene, and the like), ethers (e.g., diethylene glycol dimethyl ether, diethylene glycol diethyl ether, diethylene glycol dipropyl ether, diethylene glycol dibutyl ether, propylene glycol monomethyl ether, and the like), or the like. The solvents may be used alone or in combination of two or more.

The solvent may be a solvent that has low solubility with respect to a substrate on which the hard coating composition according to the present invention is applied, and thus the hard coating composition may be easily peeled off from the substrate after curing.

The solvent may be included at 10 to 95 wt % with respect to 100 wt % of the entire hard coating composition. When a content of the solvent is less than 10 wt %, workability may be degraded due to an increase in viscosity. On the other hand, when a content thereof is greater than 95 wt %, a drying process may take a long time and economic feasibility may decrease.

### Photoinitiator

The photoinitiator may be used without limitation as long as it is used in the art, and may be one or more selected from the group consisting of hydroxy ketones, amino ketones, and a hydrogen-abstraction-type photoinitiator.

Specifically, the photoinitiator may be 2-methyl-1-[4-(methylthio)phenyl]2-morpholine propanone-1, diphenyl ketone, benzyl dimethyl ketal, 2-hydroxy-2-methyl-1-phenyl-1-one, 4-hydroxy cyclophenyl ketone, 2,2-dimethoxy-2-phenyl-acetophenone, anthraquinone, fluorene, triphenylamine, carbazole, 3-methylacetophenone, 4-chloroacetophenone, 4,4-dimethoxyacetophenone, 4,4-diaminobenzophenone, 1-hydroxycyclohexyl phenyl ketone, benzophenone, diphenyl(2,4,6-trimethylbenzoyl)phosphine oxide, or the like. These may be used alone or in combination of two or more.

The photoinitiator may be included at 0.1 to 10 wt %, preferably, 1 to 5 wt % with respect to 100 wt % of the entire hard coating composition. When a content of the photoinitiator is less than 0.1 wt %, the curing speed of the hard coating composition may decrease and mechanical properties may be degraded due to insufficient curing caused by a decrease in the curing speed. On the other hand, when a content thereof is greater than 10 wt %, a coated film may be cracked due to overcuring.

### Additive

The additive may include one or more selected from the group consisting of an inorganic nanoparticle, a leveling agent, and a stabilizer.

### (1) Inorganic Nanoparticle

The inorganic nanoparticles may be selectively added to improve hardness of a hard coating layer. Specifically, when the inorganic nanoparticles are included in the hard coating composition, it is possible to further improve mechanical properties. More specifically, the inorganic nanoparticles are uniformly formed in a coated film and thus it is possible to improve mechanical properties such as wear resistance, scratch resistance, pencil hardness, and the like.

The inorganic nanoparticle may have an average diameter of 1 to 100 nm, particularly 1 to 80 nm, and more particularly 5 to 50 nm. When an average diameter of the inorganic nanoparticle is within these ranges, it is possible to prevent a phenomenon in which agglomeration occurs in a composition and thus form a uniform coated film, and also, to prevent a decrease in optical characteristics and mechanical properties of a coated film.

The inorganic nanoparticle may include one or more selected from the group consisting of Al₂O₃, SiO₂, ZnO, ZrO₂, BaTiO₃, TiO₂, Ta₂O₅, Ti₃O₅, ITO, IZO, ATO, ZnO—Al, Nb₂O₃, SnO, MgO, and a combination thereof, but the present invention is not limited thereto. The inorganic nanoparticle may include a metal oxide commonly used in the art.

Specifically, the inorganic nanoparticle may be Al₂O₃, SiO₂, or ZrO₂. The inorganic nanoparticle may be directly manufactured or may be a commercially available product in which the inorganic nanoparticles are dispersed in an organic solvent at a concentration of 10 to 80 wt %.

### (2) Leveling Agent

The leveling agent may include one or more selected from the group consisting of a silicone-based leveling agent, a fluorine-based leveling agent, and an acrylic leveling agent. When the leveling agent is included in the hard coating composition, it is possible to impart smoothness and coatability during the formation of a coated film.

Specifically, the leveling agent may be BYK-323, BYK-331, BYK-333, BYK-337, BYK-373, BYK-375, BYK-377, or BYK-378, all of which are commercially available from BYK Chemie GmbH, TEGO Glide 410, TEGO Glide 411, TEGO Glide 415, TEGO Glide 420, TEGO Glide 432, TEGO Glide 435, TEGO Glide 440, TEGO Glide 450, TEGO Glide 455, TEGO Rad 2100, TEGO Rad 2200N, TEGO Rad 2250, TEGO Rad 2300, TEGO Rad 2500, all of which are commercially available from Evonik TEGO Chemie GmbH, FC-4430, FC-4432, all of which are commercially available from 3M, or the like, but the present invention is not limited thereto. A leveling agent commonly used in the art may be used.

### (3) Stabilizer

The stabilizer may include one or more selected from the group consisting of hindered amine; phenyl salicylate; benzophenone; benzotriazole; nickel derivative; radical scavenger; polyphenol; phosphite; and lactone stabilizers.

The term “UV stabilizer” used herein refers to an additive that is added for the purpose of protecting an adhesive by blocking or absorbing UV rays because the cured surface of a coated film is discolored and easily broken due to decomposition caused by continuous UV ray exposure.

The UV stabilizer may be classified as an absorbent, a quencher, or a hindered amine light stabilizer (HALS) based on a mechanism. Also, the UV stabilizer may be classified as phenyl salicylate (absorbent), benzophenone (absorbent), benzotriazole (absorbent), a nickel derivative (quencher), or a radical scavenger based on a chemical structure.

However, the present invention is not specifically limited thereto as long as an UV stabilizer does not significantly change the initial color of an adhesive.

As a heat stabilizer which is a commercially applicable product, polyphenols (a primary heat stabilizer) and phosphites and lactones (a secondary heat stabilizer) may be used alone or in combination thereof. The UV stabilizer and the heat stabilizer may be used by appropriately adjusting a content thereof at a level at which an UV curing property is not affected.

### Hard Coating Film

In another exemplary embodiment of the present invention, the cured product of the hard coating composition is formed on a transparent substrate to manufacture a hard coating film.

In this case, the cured product of the hard coating composition has a thickness ranging from 50 to 300 μm. When the thickness of the cured product of the hard coating composition is less than 50 μm, impact resistance may be degraded. On the other hand, when the thickness thereof is greater than 300 μm, bending resistance may be degraded.

### Substrate

The hard coating composition according to the present invention is applied on one surface of a substrate, cured, peeled off, and then transferred to other desired substrate.

In addition, the hard coating composition according to the present invention is applied on one surface of a substrate, cured, peeled off, and then transferred to other desired substrate using a sticking agent or an adhesive.

In the present invention, the substrate on which the hard coating composition is applied may be any substrate used in the art, for example, a transparent substrate.

The transparent substrate may be any polymer film having transparency.

Specifically, the transparent substrate may be a film made of a polymer such as a cycloolefin derivative having a cycloolefin-containing monomer such as a norbornene or polycyclic norbornene-based monomer, cellulose (e.g., diacetyl cellulose, triacetyl cellulose, acetyl cellulose butylate, isobutyl ester cellulose, propionyl cellulose, butyryl cellulose or acetylpropionyl cellulose), an ethylene/vinyl acetate copolymer, polycycloolefins, polyester, polystyrene, polyamide, polyetherimide, polyacryl, polyimide, polysulfone, polyethylene, polypropylene, polymethylpentene, polyvinyl chloride, polyvinylidene chloride, polyvinyl alcohol, polyvinyl acetal, polyetherketone, polyether ether ketone, polyethersulfone, polymethyl methacrylate, polyethylene terephthalate, polybutylene terephthalate, polyethylene naphthalate, polycarbonate, polyurethane, epoxy and the like, and may also be an unoriented film or a uniaxially or biaxially oriented film. These polymers may be used alone or in combination of two or more.

Among transparent substrates, a uniaxially or biaxially oriented polyester film, which has excellent transparency and heat resistance, a cycloolefin derivative film and a polymethyl methacrylate film, which have excellent transparency and heat resistance and are capable of supporting a large-sized film, and triacetyl cellulose and isobutylester cellulose films, which have transparency and do not have optical anisotropy, may be preferably used.

The hard coating composition according to the present invention may be used in a state of a substrateless hard coating layer which is formed by applying the hard coating composition on one surface of a substrate, curing the same, and then removing the substrate. The substrateless hard coating layer may be for a rigid or flexible display. Specifically, the hard coating composition may be used as a functional layer or a substitute for a cover glass of a display such as a LCD, an OLED, a LED, a FED and the like, a touch panel of various mobile communication terminals, a smart phone or a tablet PC using the display, electronic paper or the like.

The present invention provides an image display device which includes the substrateless hard coating layer.

In addition, the present invention provides a window of a flexible display device which includes the substrateless hard coating layer.

### EXEMPLIFICATION

Hereinafter, preferred embodiments of the present invention will be described in order to aid in understanding the present invention. However, it is apparent to those skilled in the art that the description proposed herein is just a preferable example for the purpose of illustration only, and is not intended to limit or define the scope of the invention. Therefore, it should be understood that various changes and modifications can be made to the exemplary embodiments of the present invention without departing from the scope of the present invention, so that the present invention covers all such changes and modifications provided and they are within the scope of the appended claims and their equivalents. Hereinafter, all “percentage(s)” and “part(s)” representing the content in Examples and Comparative Examples are by weight unless otherwise specified.

### Preparation Examples 1 to 7

### Preparation of Hard Coating Composition

### Preparation Example 1

70 parts by weight of urethane acrylate (UA-122P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 2070 MPa and an elongation at break of 58%.

### Preparation Example 2

70 parts by weight of urethane acrylate (UA-232P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 1320 MPa and an elongation at break of 135%.

### Preparation Example 3

70 parts by weight of urethane acrylate (UA-122P commercially available from Shin-Nakamura Chemical Co., Ltd.), 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, the urethane acrylate had an elastic modulus of 2570 MPa and an elongation at break of 67%.

### Preparation Example 4

50 parts by weight of urethane acrylate (UA-122P commercially available from Shin-Nakamura Chemical Co., Ltd.), 20 parts by weight of pentaerythritol triacrylate, 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, a mixture of the urethane acrylate and pentaerythritol triacrylate had an elastic modulus of 3220 MPa and an elongation at break of 12%.

### Preparation Example 5

35 parts by weight of urethane acrylate (UA-122P commercially available from Shin-Nakamura Chemical Co., Ltd.), 35 parts by weight of pentaerythritol triacrylate, 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, a mixture of the urethane acrylate and pentaerythritol triacrylate had an elastic modulus of 3705 MPa and an elongation at break of 7%.

### Preparation Example 6

20 parts by weight of urethane acrylate (UA-122P commercially available from Shin-Nakamura Chemical Co., Ltd.), 50 parts by weight of pentaerythritol triacrylate, 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, a mixture of the urethane acrylate and pentaerythritol triacrylate had an elastic modulus of 4210 MPa and an elongation at break of 5%.

### Preparation Example 7

35 parts by weight of urethane acrylate (UA-122P commercially available from Shin-Nakamura Chemical Co., Ltd.), 35 parts by weight of dipentaerythritol hexaacrylate, 25 parts by weight of methyl ethyl ketone, 4.5 parts by weight of a photoinitiator (1-Hydroxy-cyclohexyl-phenyl-ketone), and 0.5 parts by weight of a leveling agent (BYK-3570 commercially available from BYK Chemie GmbH) were mixed using a stirrer and filtered using a filter made of polypropylene (PP) to prepare a hard coating composition. Here, a mixture of the urethane acrylate and dipentaerythritol hexaacrylate had an elastic modulus of 4570 MPa and an elongation at break of 3%.

### Examples 1 to 5 and Comparative Examples 1 to 6

### Manufacture of Hard Coating Layer

### Example 1

The hard coating composition prepared in Preparation Example 1 was applied on a polyester (PET) base film having a thickness of 50 μm in such a way that the composition has a thickness of 200 μm after curing. After coating the film, the solvent was dried and UV rays were radiated at an integrated light intensity of 500 mJ/cm2 for curing the composition to manufacture a hard coating film. Afterward, the polyester (PET) base film was peeled off to manufacture a substrateless hard coating layer having impact resistance.

### Example 2

A hard coating layer was manufactured in the same manner as in Example 1 except that the hard coating composition prepared in Preparation Example 2 was used.

### Example 3

A hard coating layer was manufactured in the same manner as in Example 1 except that the hard coating composition prepared in Preparation Example 3 was used.

### Example 4

A hard coating layer was manufactured in the same manner as in Example 1 except that a hard coating layer had a thickness of 70 μm after curing.

### Example 5

A hard coating layer was manufactured in the same manner as in Example 1 except that a hard coating layer had a thickness of 250 μm after curing.

### Comparative Example 1

A hard coating layer was manufactured in the same manner as in Example 1 except that the hard coating composition prepared in Preparation Example 4 was used.

### Comparative Example 2

A hard coating layer was manufactured in the same manner as in Example 1 except that the hard coating composition prepared in Preparation Example 5 was used.

### Comparative Example 3

A hard coating layer was manufactured in the same manner as in Example 1 except that the hard coating composition prepared in Preparation Example 6 was used.

### Comparative Example 4

A hard coating layer was manufactured in the same manner as in Example 1 except that the hard coating composition prepared in Preparation Example 7 was used.

### Comparative Example 5

A hard coating layer was manufactured in the same manner as in Example 1 except that a hard coating layer had a thickness of 10 μm after curing.

### Comparative Example 6

A hard coating layer was manufactured in the same manner as in Example 1 except that a hard coating layer had a thickness of 350 μm after curing.

### Experimental Example

Properties of the hard coating layers manufactured in Examples 1 to 5 and Comparative Examples 1 to 6 were measured in the following manner, results of which are shown in Table 1. A measurement method and an evaluation method used in the present invention are as follows.

### (1) Bending Resistance

The hard coating layers manufactured in Examples and Comparative Examples were folded in half to have an interval of 6 mm between surfaces thereof. Afterward, whether or not a folded portion was cracked when the film was unfolded again was observed by the naked eye and determined, results of which are shown in the following Table 1.

Good: no cracking at folded portion

Failure: cracking at folded portion

### (2) Impact Resistance

The hard coating layers manufactured in Examples and Comparative Examples were adhered to glass using a 50 pm optically clear adhesive (OCA) (elastic modulus of 0.08 MPa). Afterward, the maximum weight of the steel ball that did not break the glass below the hard coating film when a steel ball was freely dropped on the surface of the hard coating layer from a height of 50 cm was measured, results of which are shown in the following Table 1.

TABLE 1

| | Bending resistance | Impact resistance |
|---|---|---|
| Example 1 | Good | 35 g |
| Example 2 | Good | 50 g |
| Example 3 | Good | 40 g |
| Example 4 | Good | 35 g |
| Example 5 | Good | ≧65 g |
| Comparative Example 1 | Good | 15 g |
| Comparative Example 2 | Failure | 10 g |
| Comparative Example 3 | Failure | 5 g |
| Comparative Example 4 | Failure | 5 g |
| Comparative Example 5 | — | — |
| Comparative Example 6 | Failure | ≧65 g |

Referring to Table 1, it was confirmed that excellent bending resistance and impact resistance were exhibited in the case of Examples 1 to 5 in which an elastic modulus and elongation at break within the range of the present invitation were exhibited compared to Comparative Examples 1 to 4 in which an elastic modulus and elongation at break outside the range of the present invitation were exhibited.

In addition, it was confirmed that excellent bending resistance was exhibited in the case of Examples 1 to 5 in which the cured product of the hard coating composition had a thickness within the preferable range (50 to 300 μm) compared to Comparative Example 6 in which the cured product of the hard coating composition had a thickness above the above-described range, and it was difficult to peel off the cured product of the hard coating composition from a substrate due to an insufficient thickness of the cured product of the hard coating composition in the case of Comparative Example 5 in which the cured product of the hard coating composition had a thickness below the above-described range.

What is claimed is:

1. A hard coating composition comprising a high elongation oligomer having an elastic modulus ranging from 10 to 3000 MPa and an elongation at break ranging from 30 to 150%.

2. The hard coating composition according to claim 1, wherein the hard coating composition further comprises a solvent, a photoinitiator, an additive, or a combination thereof.

3. The hard coating composition according to claim 1, wherein the high elongation oligomer comprises a photocurable (meth)acrylate oligomer.

4. The hard coating film according to claim 3, wherein the photocurable (meth)acrylate oligomer is selected from the group consisting of epoxy (meth)acrylate, urethane (meth)acrylate, polyester (meth)acrylate, (meth)acrylate having a urethane group and a polyester group, or a combination thereof.

5. The hard coating composition according to claim 1, wherein the high elongation oligomer comprises 1 to 90 wt % of the entire hard coating composition.

6. A hard coating film comprising a cured product of the hard coating composition according to claim 1.

7. The hard coating film according to claim 6, wherein the cured product of the hard coating composition has a thickness ranging from 50 to 300 μm.

8. A window comprising the hard coating film according to claim 6.

9. An image display device comprising the window according to claim 8.

10. The image display device according to claim 9, wherein the image display device is a flexible image display device.
